(19) United States
(12) Patent Application Publication
(10) Pub. No.: US 2012/0107076 A1
(43) Pub. Date: May 3, 2012

(54) Boat Rack Systems

(76) Inventor: Paul Lieber, Lincoln, CA (US)

(21) Appl. No.: 13/285,376

(22) Filed: Oct. 31, 2011

Related U.S. Application Data
(60) Provisional application No. 61/409,455, filed on Nov. 2, 2010.

(51) Int. Cl. B60P 1/43

(52) U.S. Cl. 414/529; 414/559; 414/813

(57) ABSTRACT

A boat and boat trailer loading system used to place a boat trailer with the boat mounted thereon, onto a rack centered above a towing vehicle such as a pickup. The system comprises a winch, a head frame, a tail frame, and a ramp system comprising an upper ramp system and a lower ramp system. The winch cable and hook is routed through the head frame and hooked to a mid-point on the boat trailer frame, then pulled up the ramp system until the wheels of the boat trailer are positioned onto a left and a right wheel cradle atop the tail frame and the boat trailer tongue will rest on a pad atop the head-frame. The vehicle's trailer hitch is then left unobstructed for towing a second trailer.

### CROSS-REFERENCE TO RELATED APPLICATION

The present application is related to and claims priority from prior provisional application Ser. No. 61/409,455, filed Nov. 2, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of recreational vehicles and more specifically relates to a boat and boat trailer loading system.

### DESCRIPTION OF THE RELATED ART

Boats have been used in the fishing industry and for transportation of people for many years. While boating was predominately a means of gathering food for subsistence since early history, boating for recreation has increased exponentially in the last century. The watercraft industry has reported sales in excess of 17 billion annually and the U.S. Coast Guard reports that there are approximately 16.7 million owners of boats that are less than 25 feet in length in the U.S. About half of these owners also have a trailer for towing their boat to a location where the boat can be launched and used. These trailers may be dangerous to pull, and may prevent owners from pulling other recreational vehicles.

As an alternative boat owners often purchase small boats such that they may be transported on the top of a vehicle, placed there by manual means. This may prove dangerous if the boat is not secured in place using suitable fastening means, as the boat may come loose and fall of into traffic. A boat falling off into traffic may endanger other motorists and often destroys the boat. Additionally, lifting a boat into place may cause an individual to undergo strain from lifting, potentially causing back problems. Using this method, once the owner has arrived at the body of water he/she is left with no trailer by which to move the boat. It is desired that the boat and trailer be available at the final destination.

Various attempts have been made to solve the above-mentioned problems such as those found in Pub. No. 2004/0161322; U.S. Pat. Nos. 3,411,644; 5,741,110; 3,734,321; 5,511,928; and 5,586,856. This prior art is representative of boat hauling means. None of the above inventions and patents, taken either singly or in combination, is seen to describe the invention as claimed.

Ideally, a boat and boat trailer loading system should be user-friendly and safe, yet would operate reliably and be manufactured at a modest expense. Thus, a need exists for a reliable boat and boat trailer loading system to quickly load a boat trailer with a mounted boat, and to avoid the above-mentioned problems.

### BRIEF SUMMARY OF THE INVENTION

In view of the foregoing disadvantages inherent in the known boat loading system art, the present invention provides a novel boat and boat trailer loading system. The general purpose of the present invention, which will be described subsequently in greater detail, is to provide boat loading and transporting means leaving an unobstructed trailer hitch for hauling a second recreational item such as a camping trailer.

A boat and boat trailer loading system as disclosed herein preferably comprises a head frame assembly having a winch with a cable, and a tail frame assembly comprising an upper ramp system including an upper left ramp and an upper right ramp. The upper ramp system has a distal end and a proximate end. The boat and boat trailer loading system further comprises a lower ramp system including a lower left ramp and a lower right ramp, the lower ramp system having a first end and a second end. Additionally, a cradle frame member is included in preferred embodiments. The head frame assembly and the tail frame assembly are mountable to a vehicle frame, preferably to the top surface of a pickup cargo box. The head frame assembly comprises a left side and a right side preferably non-removably joined by a head-cross-member. The left side and the right side of the head frame assembly each have two upright support-columns.

The winch may be removably fastened to the vehicle frame or, in some embodiments, to the front wall of the pickup cargo box (or in other embodiments to the head frame assembly) and preferably has an electric motor, a hook on the cable, and a remote controller. In embodiments where the winch is removably fastened to the head frame assembly these versions may have a roller assembly having four rollers including a first roller affixed to a top side, a second roller to a bottom side, a third roller to a left side, and fourth roller to a right side of an opening such that the winch cable is able to roller-pass therethrough to attach to the boat trailer frame. The head frame assembly may comprise at least one pulley in an embodiment wherein the winch is mounted to the front wall of a pickup cargo box. The cradle frame member is preferably non-removably connected to the tail frame assembly. The tail frame assembly has a left side and a right side upright member joined by at least one cross-member. The left side and right side upright members of the tail frame assembly comprise two tubular columns each which may be square tubing, but also may be round tubing in other embodiments.

The tail frame in preferred embodiments comprises a left wheel cradle and a right wheel cradle, each one having a locking pin (or other retaining means) such that the tires of the boat trailer are able to be independently locked into the wheel cradles during transport. The left wheel cradle and the right wheel cradle are able to nestibly support the wheels of the boat trailer when the boat trailer with the boat mounted thereon are mounted onto the head frame assembly and the tail frame assembly (keeping it in place.) When the boat is mounted onto the boat trailer and loaded for transport on the boat trailer loading system, the boat and boat trailer are mount-situated above and (substantially) parallel to the vehicle frame. The cradle frame member comprises a center roller wherein the tongue of the boat trailer is able to be roller-guided forwardly and rearwardly by the cable of the winch when being loaded and unloaded. The center roller is horizontally fastened to the top surface of the cross member at a lower height than the surface-plane of the left side and the right side of the tail frame such that the cable, the boat, and the boat trailer frame do not contact the tail frame during at least one boat-trailer-loading-procedure. In this embodiment the center roller is orientated perpendicular to the frame.

The distal end of the upper ramp system is removably connectable to the cradle frame member and the proximate end of the upper ramp system is removably attached to the second end of the lower ramp system for loading and unloading (is stored during transport.) When loading for example the first end of the lower ramp system is in contact with the ground surface such that the wheels of the boat trailer are able to traverse an incline created by the lower ramp system and the upper ramp system. The cable of the winch is removably coupleable to the boat trailer and (the boat trailer having a boat located thereon) are able to be winch-manipulated onto the head frame and tail frame assemblies of the present invention. Forward traverse of the boat trailer is accomplished when the boat trailer is pulled via the winch and first contacts and rides upon the lower left ramp and the lower right ramp, then next sequentially the boat trailer moves to the upper left ramp and the upper right ramp, then the wheels of the boat trailer set into the cradle frame member. In this sequence the boat trailer is able to be moved on its wheels into a loaded position (and reversed to perform an unload.)

The upper ramp system and the lower ramp system preferably comprise couplers such that the upper ramp system and the lower ramp system remain connected and supported while in use, and are able to be separated from each other for transport. The boat trailer is able to be cable-pulled up the lower ramp system onto the upper ramp system then onto the cradle frame member for transport-attachment above the plane of the vehicle frame. When the boat trailer with the boat thereon is mounted onto the head frame and the tail frame, a trailer hitch located at the rear of the vehicle is able to remain unobstructed allowing the vehicle to tow a second trailer. The truck is then free to pull other recreational devices such as camping trailers or the like.

A method of use for a boat and boat trailer loader system as disclosed herein may comprise the steps of: attaching a lower ramp system and an upper ramp system to a tail frame assembly; extending a cable through a roller assembly located on a head frame assembly; attaching the cable to a trailer frame with a boat mounted thereon; pulling the trailer with the boat up an inclined plane formed by the lower ramp system and the upper ramp system (attached to each other); positioning the wheels of the trailer into a left wheel cradle and a right wheel cradle (simultaneously); locking the wheels of the trailer with the boat mounted thereon to a cradle frame member; hauling the trailer with the boat to a water recreation area; unlocking the wheels of the trailer with the boat; and extending the cable using the winch to lower the trailer with the boat to a ground surface such that the boat and trailer may be used.

The present invention holds significant improvements and serves as a boat and boat trailer loading system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, boat rack systems, constructed and operative according to the teachings of the present invention.

FIG. 1 shows a perspective view illustrating an in-use condition of a boat and boat trailer loading system according to an embodiment of the present invention.

FIG. 2 is a perspective view illustrating the boat and boat trailer loading system as used for loading and unloading according to an embodiment of the present invention of FIG. 1.

FIG. 3 is a perspective view illustrating a head frame assembly of a boat and boat trailer loading system according to an embodiment of the present invention of FIG. 1.

FIG. 4 is a perspective view illustrating a tail frame assembly with upper ramp system and lower ramp system of a boat and boat trailer loading system according to an embodiment of the present invention of FIG. 1.

FIG. 5 is a flowchart illustrating a method of use for a boat and boat trailer loading system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a boat loading system and more particularly to a boat and boat trailer loading system as used to improve the convenience and efficiency of moving a boat and trailer between locations.

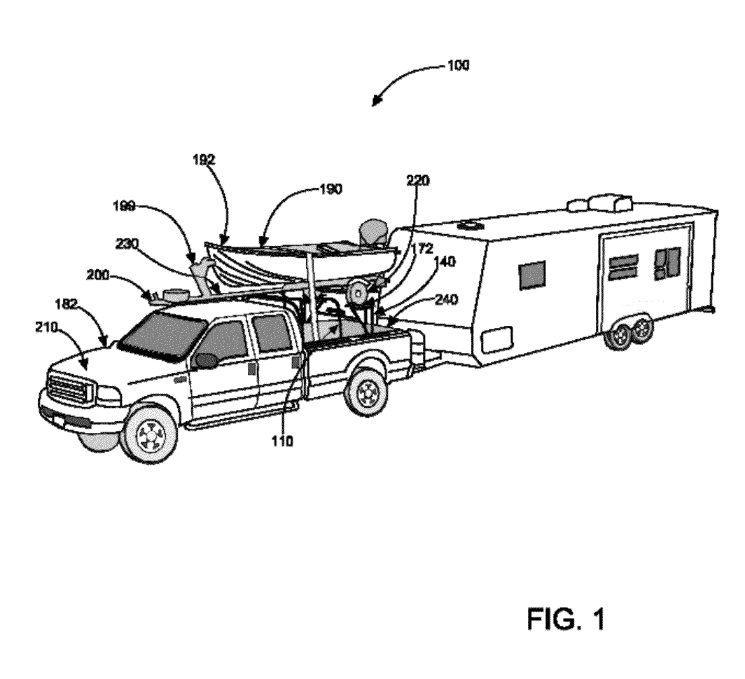

Referring to the drawings by numerals of reference there is shown in FIG. 1, a perspective view illustrating an in-use condition of boat and boat trailer loading system 100 according to an embodiment of the present invention.

Boat and boat trailer loading system 100 preferably comprises head frame assembly 110 having winch 120 with cable 130, and tail frame assembly 140. Boat and boat trailer loading system 100 preferably comprises upper ramp system 150 including upper left ramp 152 and upper right ramp 154. Upper ramp system 150 has distal end 156 and proximate end 158. Lower ramp system 160 includes lower left ramp 162 and lower right ramp 164, lower ramp system 160 having first end 166 and second end 168. Boat and boat trailer loading system 100 also preferably comprises cradle frame member 170. Winch 120 is removably fastened to vehicle frame 180 and cradle frame member 170 is connected to tail frame assembly 140. Head frame assembly 110 and tail frame assembly 140 are mountable to vehicle frame 180, as shown. When boat 190 and boat trailer 199 is mounted thereon boat and boat trailer loading system 100, boat 190 and boat trailer 199 are mount-situated above vehicle frame 180 and forward hull 192 of boat 190 and tongue of trailer 200 are aligned facing toward front of vehicle 210 and are substantially parallel to vehicle frame 180.

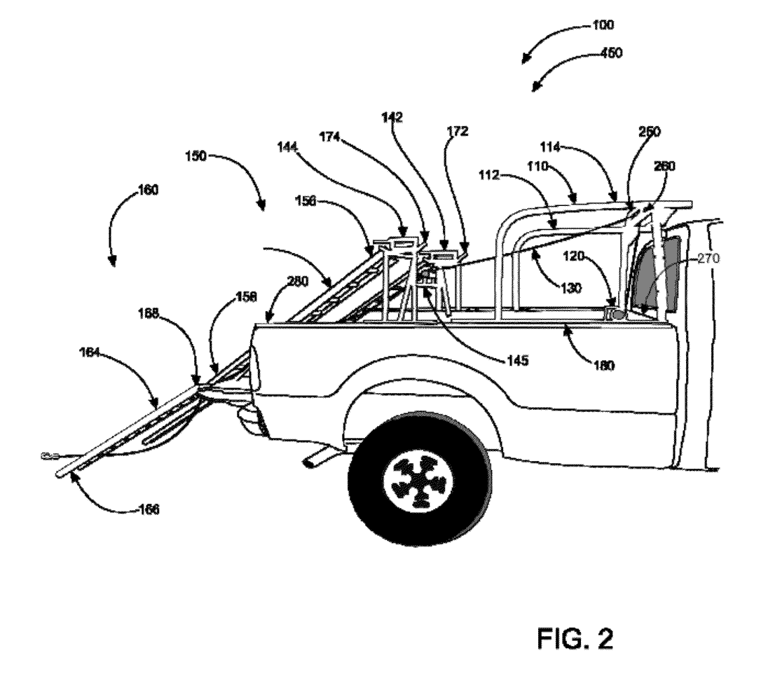

Referring now to FIG. 2, is a perspective view illustrating boat and boat trailer loading system 100 according to an embodiment of the present invention of FIG. 1.

When used for loading and unloading, distal end 156 of upper ramp system 150 is removably connected to cradle frame member 170 and proximate end 158 of upper ramp system 150 is removably attached to second end 168 of lower ramp system 160. First end 166 of lower ramp system 160 is in contact with ground surface such that wheels 220 of boat trailer 199 are able to traverse an incline created by lower ramp system 160 and upper ramp system 150. Cable 130 of winch 120 is removably coupleable to boat trailer frame 230, boat trailer 199 having boat 190 located thereon, such that boat trailer 199 with boat 190 are able to be winch-manipulated onto head frame assembly 110 and tail frame assembly 140 of boat and boat trailer loading system 100 into a loaded condition. Forward traverse of boat trailer 199 is accomplished when boat trailer 199 is pulled via winch 120, and first contacts and rides upon lower left ramp 162 and lower right ramp 164, then sequentially moves to upper left ramp 152 and upper right ramp 154, then wheels 220 of boat trailer 199 set into cradle frame member 170. Boat trailer 199 is able to be cable-pulled up lower ramp system 160 onto upper ramp system 150 then onto cradle frame member 170 for transport-attachment above a plane of vehicle frame 180. Boat trailer 199 with boat 190 thereon is mounted on head frame assembly 110 and tail frame assembly 140, allowing a trailer hitch located at the rear of vehicle 240 to remain unobstructed allowing vehicle 182 to tow a second trailer (or the like.)

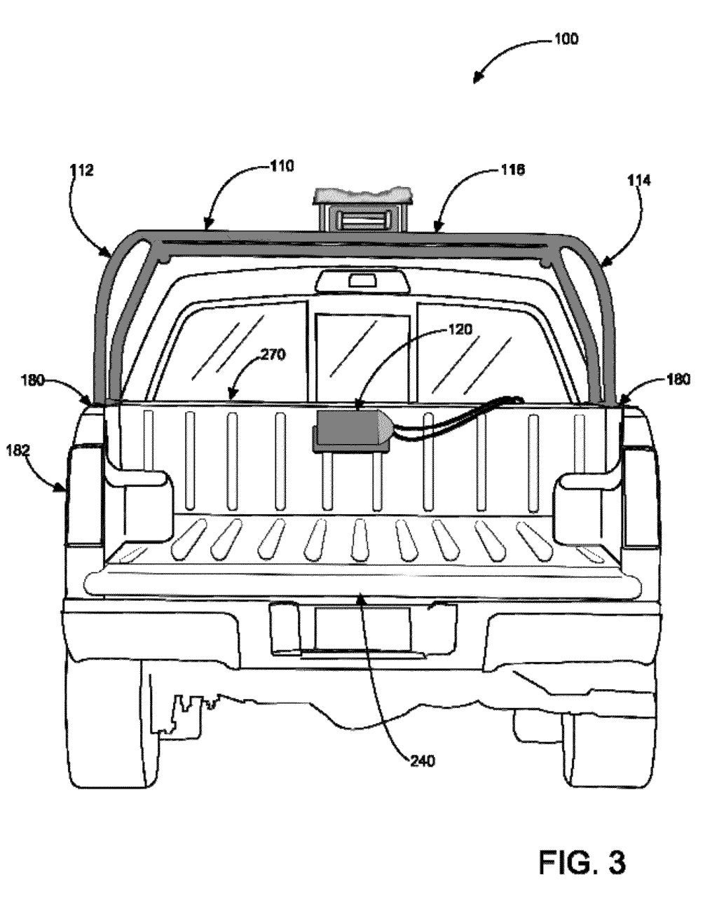

Referring now to FIG. 3, is a perspective view illustrating head frame assembly 110 of boat and boat trailer loading system 100 according to an embodiment of the present invention of FIG. 1.

Head frame assembly 110 comprises left side 112 and right side 114 non-removably joined by head-cross-member 116 in preferred embodiments. Left side 112 and right side 114 of head frame assembly 110 preferably comprise two (or more) upright support-columns each. Head frame assembly 110 preferably comprises roller assembly 250 having a plurality of rollers (preferably four) including a first roller affixed to the top side, a second roller to the bottom side, a third roller to the left side, and a fourth roller to the right side of an opening such that cable 130 is able to roller-pass therethrough to attach to boat trailer frame 230.

Head frame assembly 110 in alternate embodiments may comprise at least one pulley 260 but the exact configuration may depend on where winch 120 is mounted in the particular embodiment. Winch 120 may be mounted to vehicle frame 180 or to the front wall 270 of pickup cargo box 280 (with suitable stiffening support provided.) Winch 120 also may be removably fastenenable to head frame assembly 110 in certain embodiments. Winch 120 preferably comprises an electric motor, a hook, and a remote controller. Upper ramp system 150 and lower ramp system 160 comprise couplers such that upper ramp system 150 and lower ramp system 160 remain connected while in use and are able to be separated from each other for storage during transport. Second end 168 of lower ramp system 160 and proximate end 158 of upper ramp system 150 may use a pickup tailgate for mid-support and may couple to a tailgate at the same approximate location in various embodiments. Remote control provides that boat 190 and boat trailer 199 may be loaded in a safe manner.

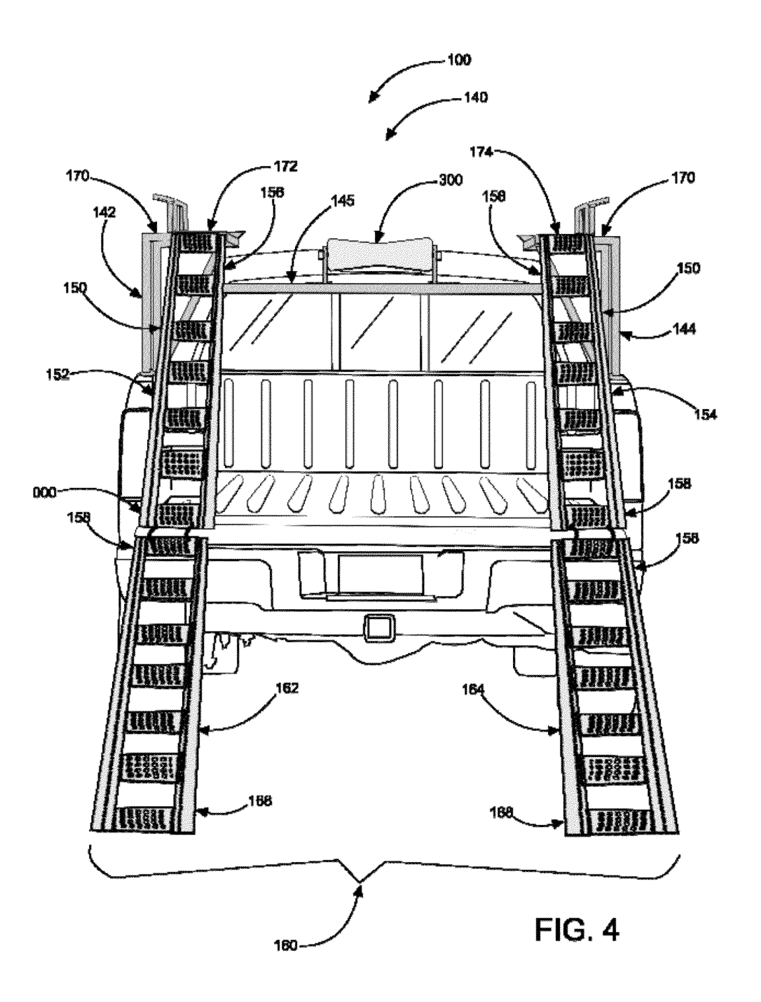

Referring now to FIG. 4, a perspective view illustrating tail frame assembly 140 with upper ramp system 150 and lower ramp system 160 of boat and boat trailer loading system 100 according to an embodiment of the present invention of FIGS. 1 and 2.

Tail frame assembly 140 preferably comprises left side upright member 142 and right side upright member 144 joined by at least one cross-member 145. Left side upright member 142 and right side upright member 144 of tail frame assembly 140 comprise two tubular columns each in preferred embodiments. Tail frame assembly 140 may comprise left wheel cradle 172 and right wheel cradle 174 and further may comprise a locking pin such that wheels 220 of boat trailer 199 are able to be independently locked into left wheel cradle 172 and right wheel cradle 174. Left wheel cradle 172 and right wheel cradle 174 are able to nestibly support wheels 220 of boat trailer 199 when boat trailer 199 with boat 190 are mounted onto head frame assembly 110 and tail frame assembly 140. Cradle frame member 170 comprises center roller 300, wherein tongue of boat trailer 199 is able to be roller-guided forwardly and rearwardly by cable 130 of winch 120. Center roller 300 is horizontally fastened to top surface of cross-member 145 at a lower height than a surface-plane of left side upright member 142 and right side upright member 144 such that cable 130, boat 190, and boat trailer frame 230 do not contact tail frame assembly 140 during at least one boat-trailer-loading-procedure. In transport the present invention provides that boat trailer 199 is able to travel in a (substantially) parallel condition to both vehicle 182 (vehicle frame 180) and the road surface to minimize stress to both boat trailer 199 and vehicle frame 180 of vehicle 182.

Boat and boat trailer loading system 100 according to an embodiment of the present invention of FIGS. 1-4, may be sold as kit 450 comprising the following parts: at least one winch 120 having cable 130 and controller; at least one head frame assembly 110; at least one tail frame assembly 140; at least one upper ramp system 150 and lower ramp system 160; and at least one set of user instructions. Boat and boat trailer loading system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, for use with trailers without boats (may be ATVs, other recreational devices such as jet skiis or the like, parts may be sold separately, etc., may be sufficient.

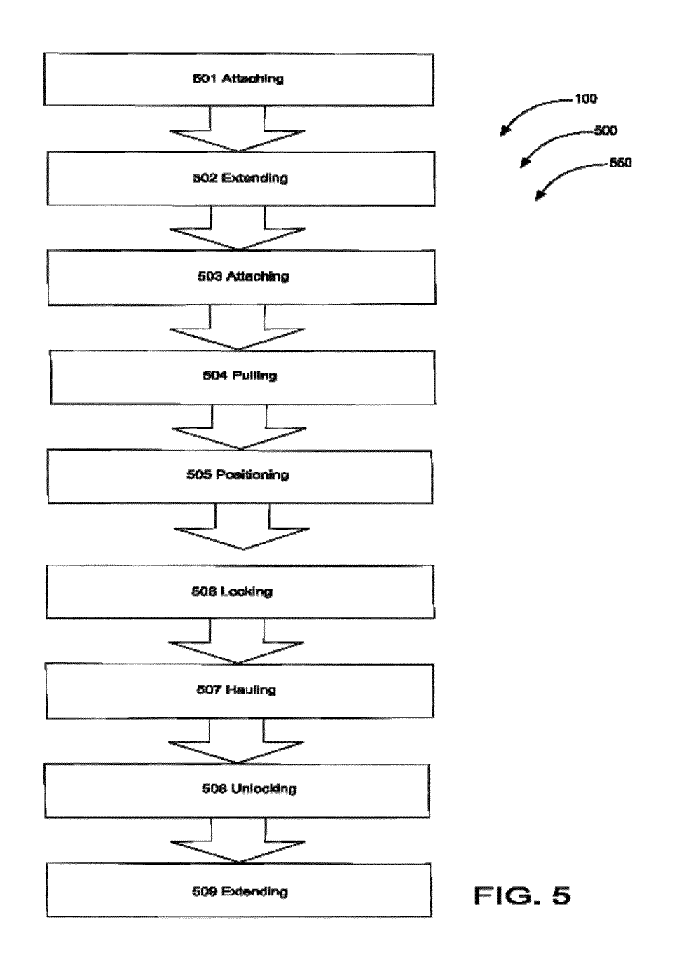

Referring now to FIG. 5, a flowchart 550 illustrating a method of use 500 for boat and boat trailer loading system 100 according to an embodiment of the present invention of FIGS. 1-4.

A method of use 500 for boat and boat trailer loading system 100 may comprise the steps of: step one 501 attaching lower ramp system 160 and upper ramp system 150 to tail frame assembly 140; step two 502 extending cable 130 through roller assembly 250 located on head frame assembly 110; and step three 503 attaching cable 130 to boat trailer frame 230 (with boat 190 mounted thereon); step four 504 pulling boat trailer 199 with boat 190 up an inclined plane formed by lower ramp system 160 and upper ramp system 150; step five 505 positioning wheels 220 of boat trailer 199 into left wheel cradle 172 and right wheel cradle 174; step six 506 locking wheels 220 of boat trailer 199 with boat 190 mounted thereon to cradle frame member 170; step seven 507 hauling boat trailer 199 with boat 190 to a water recreation area; step eight 508 unlocking wheels 220 of boat trailer 199 with boat 190; and step nine 509 extending cable 130 using winch 120 to lower boat trailer 199 with boat 190 to a ground surface for use.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A boat and boat trailer loading system comprising:
a head frame assembly having a winch with a cable;
a tail frame assembly comprising;
an upper ramp system including an upper left ramp and an upper right ramp, said upper ramp system having a distal end and a proximate end;
a lower ramp system including a lower left ramp and a lower right ramp, said lower ramp system having a first end and a second end; and
a cradle frame member;
wherein said head frame assembly and said tail frame assembly are mountable to a vehicle frame;
wherein said winch is removably fastened to said vehicle frame;
wherein said cradle frame member is connected to said tail frame assembly;
wherein said distal end of said upper ramp system is removably connectable to said cradle frame member and said proximate end of said upper ramp system is removably attachable to said second end of said lower ramp system and said first end of said lower ramp system is in contact with a ground surface such that wheels of a boat trailer are able to traverse an incline created by said lower ramp system and said upper ramp system;
wherein said cable of said winch is removably coublable to said boat trailer, said boat trailer having a boat located thereon such that said boat trailer with said boat are able to be winch-manipulated onto said head frame assembly and said tail frame assembly of said boat and boat trailer loading system to load said boat trailer with said boat onto said vehicle;
wherein forward traverse of said boat trailer is accomplished when said boat trailer is pulled via said winch and first contacts and rides upon said lower left ramp and said lower right ramp, then next sequentially moves to said upper left ramp and said upper right ramp, then wheels of said boat trailer set into said cradle frame member; and
wherein said boat trailer is able to be cable-pulled up said lower ramp system onto said upper ramp system then onto said cradle frame member for transport-attachment above a plane of said vehicle frame and parallel to said vehicle frame, and wherein said boat trailer with said boat thereon is mounted on said head frame and said tail frame, allowing a trailer hitch located at a rear of said vehicle to remain unobstructed allowing said vehicle to tow a second trailer.

2. The boat and boat trailer loading system of claim 1 wherein said tail frame assembly comprises left side and a right side upright member joined by at least one cross-member.

3. The boat and boat trailer loading system of claim 2 wherein said left side and said right side upright members of said tail frame assembly comprise two tubular columns each.

4. The boat and boat trailer loading system of claim 1 wherein said tail frame comprises a left wheel cradle and a right wheel cradle.

5. The boat and boat trailer loading system of claim 4 wherein said left wheel cradle and said right wheel cradle further comprise a locking pin such that tires of said boat trailer are able to be independently locked into said cradle to prevent movement forward and backward of said tires and said boat trailer.

6. The boat and boat trailer loading system of claim 4 wherein said left wheel cradle and said right wheel cradle are able to nestibly support said wheels of said boat trailer when said boat trailer with said boat thereon are mounted onto said head frame assembly and said tail frame assembly.

7. The boat and boat trailer loading system of claim 1 wherein said cradle frame member comprises a center roller, wherein a tongue of said boat trailer is able to be roller-guided forwardly and rearwardly by said cable of said winch.

8. The boat and boat trailer loading system of claim 7 wherein said center roller is horizontally fastened to a top surface of said cross member at a lower height than a surface-plane of said left side and said right side of said tail frame such that said cable, said boat, and said boat trailer frame do not contact said tail frame during at least one boat-trailer-loading-procedure.

9. The boat and boat trailer loading system of claim 1 wherein said head frame assembly comprises a left side and a right side non-removably joined by a head-cross-member.

10. The boat and boat trailer loading system of claim 9 wherein said left side and said right side of said head frame assembly comprise two upright support-columns each.

11. The boat and boat trailer loading system of claim 1 wherein said head frame assembly comprises a roller assembly having four rollers including a first roller affixed to a top side, a second roller to a bottom side, a third roller to a left side, and fourth roller to a right side of an opening such that said cable is able to roller-pass therethrough to attach to said boat trailer frame.

12. The boat and boat trailer loading system of claim 1 wherein said head frame assembly comprises at least one pulley.

13. The boat and boat trailer loading system of claim 1 wherein said winch comprises an electric motor, a hook and a remote controller.

14. The boat and boat trailer loading system of claim 13 wherein said winch is removably fastenenable to said head frame assembly.

15. The boat and boat trailer loading system of claim 1 wherein when said boat and said boat trailer is mounted thereon, said boat and said boat trailer are mount-situated above said vehicle frame and parallel to said vehicle frame.

16. The boat and boat trailer loading system of claim 1 wherein when said boat and said boat trailer is mounted thereon, a forward hull of said boat and said tongue of said trailer, are aligned facing toward a front of said vehicle and substantially parallel to said vehicle frame.

17. The boat and boat trailer loading system of claim 1 wherein said upper ramp system and said lower ramp system comprise couplers such that said upper ramp system and said lower ramp system remain connected while in use and are able to be separated from each other for transport.

18. A boat and boat trailer loading system comprising:
a head frame assembly;
a winch with a cable;
a tail frame assembly comprising;
an upper ramp system including an upper left ramp and an upper right ramp, said upper ramp system having a distal end and a proximate end;
a lower ramp system including a lower left ramp and a lower right ramp, said lower ramp system having a first end and a second end; and
a cradle frame member;
wherein said head frame assembly and said tail frame assembly are mountable to a vehicle frame;
wherein said head frame assembly comprises a left side and a right side non-removably joined by a head-cross-member;
wherein said left side and said right side of said head frame assembly comprise two upright support-columns each;
wherein said winch is removably fastened to a vehicle frame;
wherein said winch comprises an electric motor, a hook and a remote controller;
wherein said head frame assembly comprises a roller assembly having four rollers including a first roller affixed to a top side, a second roller to a bottom side, a third roller to a left side, and fourth roller to a right side of an opening such that said cable is able to roller-pass therethrough to attach to said boat trailer frame;
wherein said cradle frame member is connected to said tail frame assembly;
wherein said tail frame assembly comprises a left side and a right side upright member joined by at least one cross-member;
wherein said left side and said right side upright members of said tail frame assembly comprise two tubular columns each;
wherein said tail frame comprises a left wheel cradle and a right wheel cradle;
wherein said left wheel cradle and said right wheel cradle further comprise a locking pin such that tires of said boat trailer are able to be independently locked into said cradle;
wherein said left wheel cradle and said right wheel cradle are able to nestibly support said wheels of said boat trailer when said boat trailer with said boat thereon are mounted onto said head frame assembly and said tail frame assembly;
wherein when said boat and said boat trailer is mounted thereon, said boat and said boat trailer are mount-situated above and parallel to said vehicle frame;
wherein said cradle frame member comprises a center roller, wherein a tongue of said boat trailer is able to be roller-guided forwardly and rearwardly by said cable of said winch said tongue moving along said center roller;
wherein said center roller is horizontally fastened to a top surface of said cross member at a lower height than a surface-plane of said left side and said right side of said tail frame such that said cable, said boat, and said boat trailer frame do not contact said tail frame during at least one boat-trailer-loading-procedure;
wherein said distal end of said upper ramp system is removably connected to said cradle frame member and said proximate end of said upper ramp system is removably attached to said second end of said lower ramp system and said first end of said lower ramp system is in contact with a ground surface such that wheels of a boat trailer are able to traverse an incline created by said lower ramp system and said upper ramp system;
wherein said cable of said winch is removably coupleable to said boat trailer, said boat trailer having a boat located thereon such that said boat trailer with said boat are able to be winch-manipulated onto said head frame assembly and said tail frame assembly of said boat and boat trailer loading system to load said boat trailer with said boat onto said vehicle;
wherein forward traverse of said boat trailer is accomplished when said boat trailer is pulled via said winch and first contacts and rides upon said lower left ramp and said lower right ramp, then next sequentially moves to said upper left ramp and said upper right ramp, then wheels of said boat trailer set into said cradle frame member;
wherein said upper ramp system and said lower ramp system comprise couplers such that said upper ramp system and said lower ramp system remain connected while in use and are able to be separated from each other for transport; and
wherein said boat trailer is able to be cable-pulled up said lower ramp system onto said upper ramp system then onto said cradle frame member for transport-attachment above and parallel to a plane of said vehicle frame, and wherein said boat trailer with said boat thereon is mounted on said head frame and said tail frame, allowing a trailer hitch located at a rear of said vehicle to remain unobstructed allowing said vehicle to tow a second trailer.

19. The boat and boat trailer loading system of claim 18 comprising a kit having:
said winch having said cable and said controller;
said head frame assembly;
said tail frame assembly;
said upper ramp system and said lower ramp system; and
at least one set of user instructions.

20. A method of use for a boat and boat trailer loader system comprising the steps of:
attaching a lower ramp system and an upper ramp system to a tail frame assembly;
extending a cable through a roller assembly located on a head frame assembly;
attaching said cable to a trailer frame with a boat mounted thereon;
pulling said trailer with said boat up an inclined plane formed by said lower ramp system and said upper ramp system;
positioning the wheels of said trailer into a left wheel cradle and a right wheel cradle;
locking wheels of said trailer with said boat mounted thereon to a cradle frame member;
hauling said trailer with said boat to a water recreation area;
unlocking said wheels of said trailer with said boat; and
extending said cable using said winch to lower said trailer with said boat to a ground surface.
